(19) United States
(12) Patent Application Publication
(10) Pub. No.: US 2017/0071251 A1
(43) Pub. Date: Mar. 16, 2017

(54) SMOKING DEVICE

(71) Applicant: Xeo Holding GmbH, Hannover (DE)

(72) Inventor: Markus Goch, Hannover (DE)

(21) Appl. No.: 15/121,943

(22) PCT Filed: Feb. 27, 2015
(86) PCT No.: PCT/EP2015/054217

§ 371 Date: Aug. 26, 2016

(30) Foreign Application Priority Data
Feb. 27, 2014 (DE) 20 2014 001 718.2
Oct. 1, 2014 (DE) 10 2014 114 308.6

(51) Int. Cl. A24F 47/00; H05B 1/02

(52) U.S. Cl. CPC A24F 47/008; H05B 1/0244; H05B 2203/021

(57) ABSTRACT

The invention relates to a smoking device having a housing (1), having a liquid evaporator (2), which is arranged in the housing (1) and has a reservoir (3) for liquid and also a liquid-heating device (4) for evaporating the liquid into liquid vapor, and having a tobacco heater (5), which is arranged in the housing (1) and has a heating chamber (6) for accommodating a tobacco substance in a chamber interior (6a) and also a chamber-heating device (7) for generating tobacco vapor from the tobacco substance, and having an intake-opening arrangement (8) for taking in the liquid vapor, and for taking in the tobacco vapor, from the housing (1), wherein the liquid vapor flows in a liquid-flow channel (9) from the liquid-heating device (4) to the intake-opening arrangement (8) and the tobacco vapor flows in a tobacco-flow channel (10) from the chamber interior (6a) to the intake-opening arrangement (8). The invention is characterized in that the liquid-flow channel (9) runs in the housing (1), outside the chamber interior (6a).

The invention relates to a smoking device according to the preamble of claim 1.

Alternatives to conventional cigarettes, cigars, pipes and other devices or disposable articles for burning tobacco are provided by various smoking devices from the prior art.

These include, in particular, electronic cigarettes. These usually function by the principle of a liquid evaporator, in accordance with which a liquid which is to be evaporated, and may be mixed with nicotine or other flavouring or active substances, passes out of a reservoir, by means of a wick, to an electrically supplied heating coil and is evaporated there. This functional principle makes it possible, within a very short reaction time, for comparatively large quantities of liquid to be evaporated into an aerosol and for the latter to be breathed in a user drawing on the electronic cigarette. The process also allows the quantity of liquid vapor to be linked to the intensity with which the user draws on the electronic cigarette.

The prior art also discloses electric tobacco heaters in which, following initial heating to a pre-heating temperature, a tobacco substance is further heated to a process temperature, at which process temperature the tobacco substance gives off a tobacco vapor without the tobacco burning to any significant extent, as is the case with a conventional cigarette. As a result, the tobacco vapor produced by the tobacco heater has the pleasant aroma and the warm temperature of conventional cigarette smoke, but is free of the significant harmful constituents of this smoke, which result from the burning process.

The disadvantage with the electronic cigarettes above is that the vapor generated by them has a lower temperature than conventional tobacco smoke, and the warm aroma of tobacco is also missing therefrom. It is a disadvantage of the tobacco heaters which are known from the prior art, in addition, that these can generate only a small quantity of vapor and it is also the case that this quantity of vapor cannot be adjusted readily by the user sucking on a mouthpiece. Added to this is the fact that the tobacco heaters have to be pre-heated to a pre-heating temperature and this operation of heating can last up to thirty seconds, which signifies a considerable loss of convenience for the user in particular in relation to conventional cigarettes.

In order, then, to provide users with a vapor which has nicotine and a tobacco flavour, but no harmful substances caused by burning tobacco, the American laid-open application US 2013/0014772 A1, from which the present invention proceeds, proposes a smoking device in which an extraction substance evaporated by the evaporator principle above is guided through a heating chamber of a tobacco heater in order for the nicotine from the tobacco to be absorbed into the vapor there and passed on to a mouthpiece, at which the user can then breathe in said vapor.

The device known from this prior art, however, is disadvantageous in so far as the vapor with the extraction substance is guided all the way along the length of the heating chamber. This is because dryness within the heating chamber is advantageous in order for a warm tobacco aroma and a corresponding vapor to be achieved in a reliable manner. As a result of the arrangement according to this prior art, however, it is necessarily the case that the liquid and the corresponding moisture accumulate in the heating chamber while the user is breathing in the vapor. This means that the type of vapor generation in the heating chamber which would actually be desired is prevented by the evaporated liquid flowing through. It is precisely for this reason that the advantages of the two basic approaches to vapor generation cannot be combined effectively.

Against this background, it is an object of the invention for such a smoking device, which combines basically the functionality of a liquid evaporator and of a tobacco heater, to be developed further such that the respective advantages of the individual processes can supplement one another effectively.

The aforementioned problem is solved, in the case of a smoking device having the features of the preamble of claim 1, by the features of the characterizing part of claim 1.

Essential to the invention is the finding that the flow channel through which the liquid vapor flows from the liquid evaporator to an intake opening of the smoking device runs outside an interior of the heating chamber in which the tobacco substance is heated. This means that the liquid vapor does not flow through the heating chamber and does not adversely affect the generation of the tobacco vapor. The invention therefore provides a combination of these two vapor-generating processes, combining the advantages of each. The liquid vapor provides for the—straightforwardly controllable—breathing-in volume, whereas the tobacco heater provides the tobacco aroma and the temperature. It has been found that even a small volume of tobacco vapor from the tobacco heater is sufficient in order to influence the aroma and the temperature sensitivity of the liquid vapor to a considerable extent.

This state of the flow channel for the liquid vapor, which may also be referred to as the liquid-flow channel, running outside the heating-chamber interior may be implemented, first of all, in that, in contrast to the closest prior art, it is not the tobacco heater which follows the liquid evaporator in the flow direction; rather, the tobacco heater is arranged upstream—as seen from the liquid evaporator. In such a case, the tobacco vapor can then be guided past the liquid evaporator for example in the manner of a bypass, in which case the two flow channels are then guided together downstream of the liquid evaporator.

It is also possible, however, for the tobacco vapor to be guided through the liquid evaporator itself. This variant is described in the preferred embodiment according to claim 2.

As an alternative, however, it may also be the case that the liquid-flow channel is guided past the heating chamber and is guided together with the flow channel for the tobacco vapor—referred to here as the tobacco-flow channel—only once the tobacco vapor has already left the chamber. The liquid-flow channel thus forms a kind of “bypass” of the heating chamber. This alternative is described in a preferred embodiment according to dependent claim 3.

A dedicated module is preferably provided in each case for the liquid evaporator and for the tobacco heater. These modules may also be arranged in respectively dedicated housing parts which, in turn, are connected to one another in a releasable manner, this being the subject matter of preferred dependent claim 4. This also makes it possible to vary the configuration of the order of the modules in respect of the flow direction between the tobacco-heater module and the liquid-evaporator module.

Bayonet connections between the individual modules here constitute particularly preferred means of establishing a connection, as is described by dependent claim 5.

According to dependent claim 6, it is also possible to provide a storage-battery module and other modules in addition to the liquid-evaporator module and the tobacco-heater module, wherein the storage-battery module can provide the electrical energy both for the tobacco-heater module and for the liquid-evaporator module.

It is further advantageous if the process temperature of the tobacco heater, at which temperature the tobacco vapor is produced from the tobacco substance, can be adjusted and can be adjusted, in particular, by a touch-contact device. This is described in dependent claim 8.

The basic capacity for release between the liquid-evaporator module and the tobacco-heater module can advantageously be used so that detachment of the liquid-evaporator module from the tobacco-heater module creates an access to the heating chamber, in which the tobacco substance which is to be evaporated can be introduced. This is the subject matter of dependent claim 9.

Advantageous configurations of the liquid-flow channel and of the tobacco-flow channel as well as of the course taken by the air stream from an inlet-opening arrangement are described in dependent claims 10 to 13.

In a variant according to dependent claim 11, provision is made that the entering air stream—instead of merely passing an outlet of the heating chamber—runs through the heating chamber in order to achieve more intensive uptake of the tobacco vapor. A development of this variant is set forth in dependent claim 14, in which provision is made that a separating arrangement separates a channel for this air passage from the tobacco substance.

Further details, features, aims and advantages of the present invention will be explained more specifically hereinbelow with reference to a drawing, which represents exemplary embodiments only and in which:

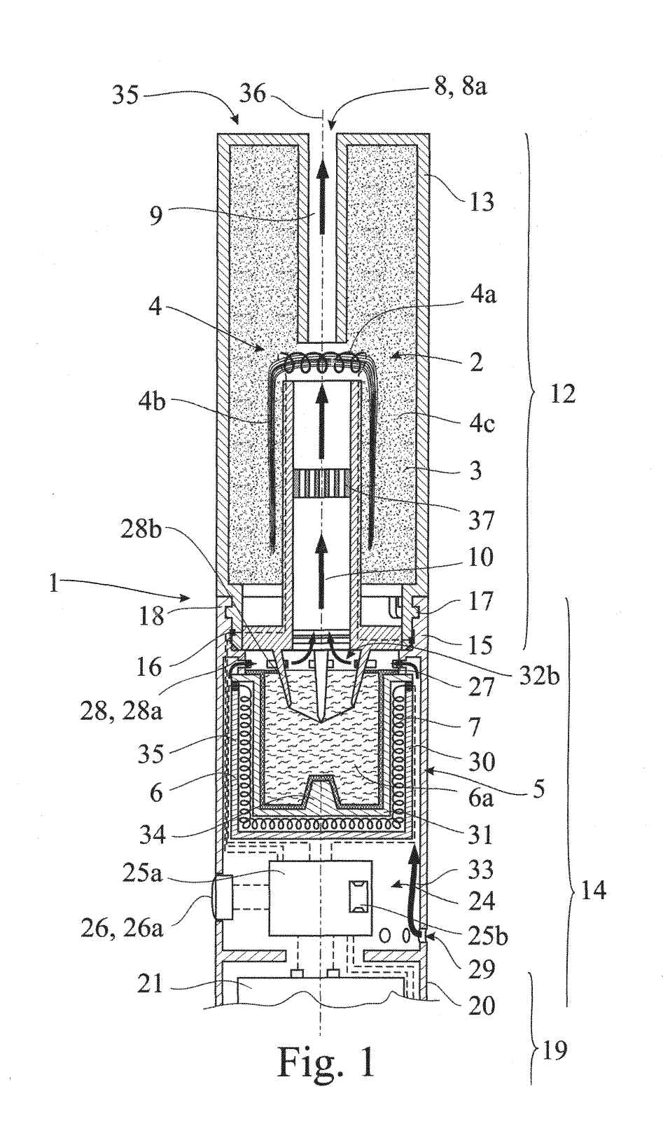

FIG. 1 shows a side view of a longitudinal section of a proposed smoking device according to a first exemplary embodiment,

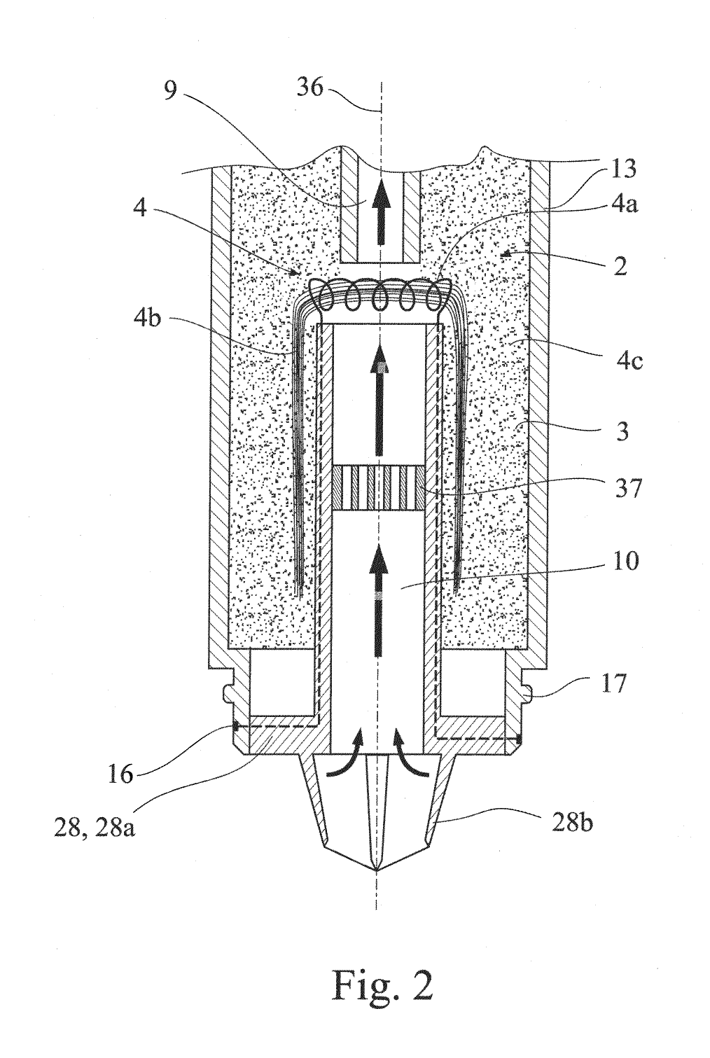

FIG. 2 shows an enlarged view, as seen in longitudinal section, of the liquid evaporator of the proposed smoking device from FIG. 1,

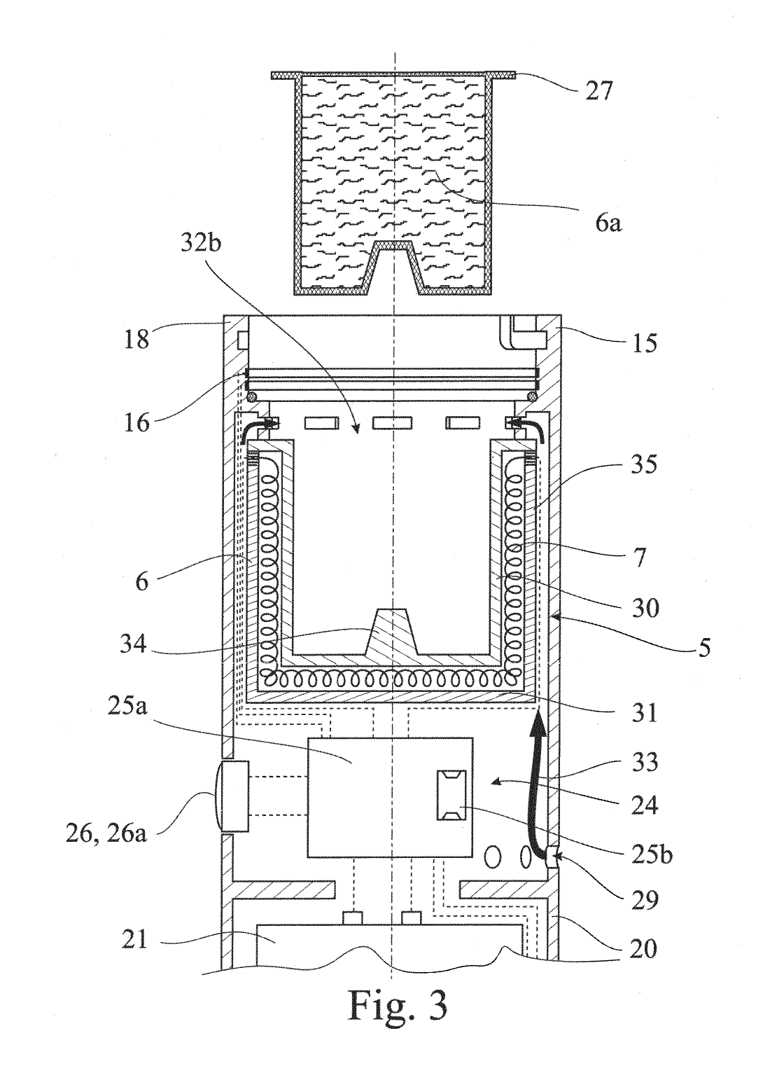

FIG. 3 shows an enlarged view, as seen in longitudinal section, of the tobacco heater of the proposed smoking device from FIG. 1,

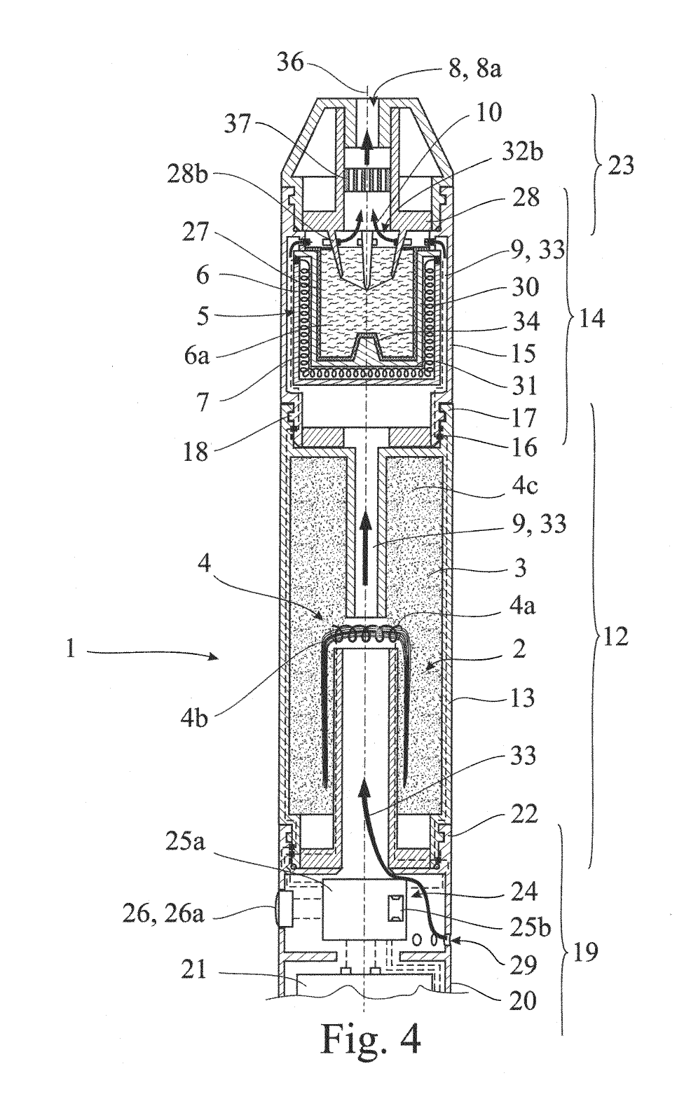

FIG. 4 shows a side view of a longitudinal section of a proposed smoking device according to a second exemplary embodiment,

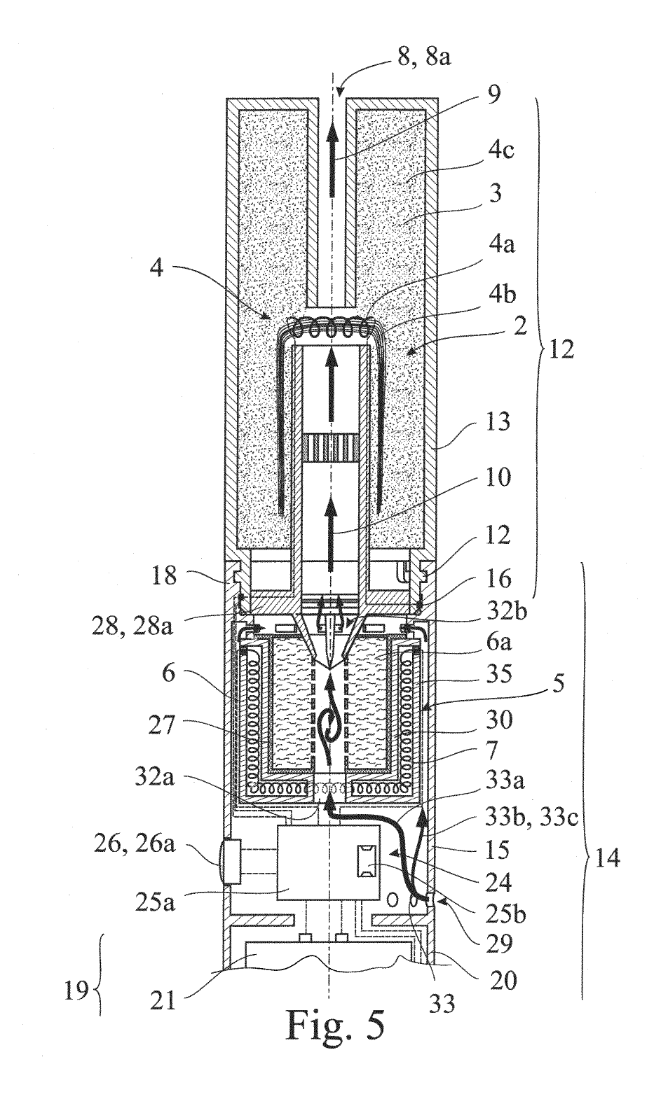

FIG. 5 shows a side view of a longitudinal section of a proposed smoking device according to a third exemplary embodiment, and

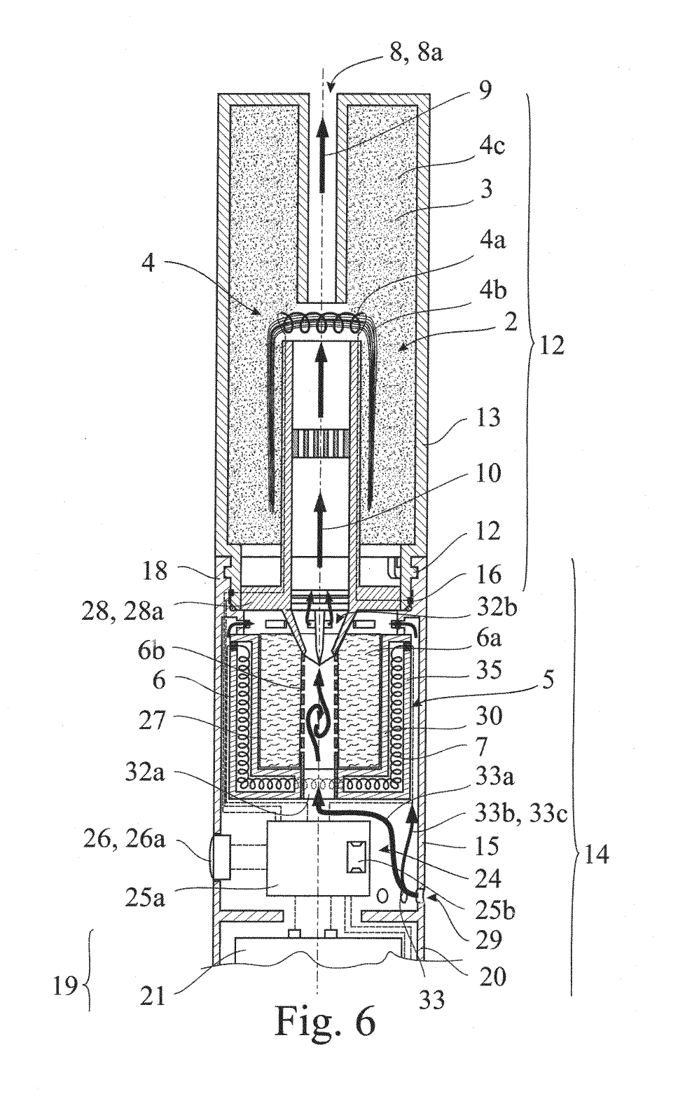

FIG. 6 shows a side view of a longitudinal section of a proposed smoking device according to a fourth exemplary embodiment.

The proposed smoking devices illustrated in FIGS. 1, 2, 3 and 4 have in each case a housing 1 and a liquid evaporator 2, which is arranged in the housing 1.

This liquid evaporator 2, for its part, has a reservoir 3 for liquid and also a liquid-heating device 4 for evaporating the liquid into liquid vapor. The liquid-heating device 4 here functions by a principle which is known per se from the prior art and in accordance with which a heating coil 4a is heated electrically and, by means of a wick 4b, the liquid from the reservoir 3, which may have for example a nonwoven 4c impregnated with liquid, is transported to the heating coil 4a, where the liquid is then evaporated.

The smoking device 1, as proposed, also has a tobacco heater 5, which is arranged in the housing 1, wherein said tobacco heater 5 has a heating chamber 6 for accommodating a tobacco substance in a chamber interior 6a and also a chamber-heating device 7 for generating tobacco vapor from the tobacco substance. It is also the case that the functioning of this chamber-heating device 7 for generating tobacco vapor is known per se from the prior art, and is also referred to therein as “tobacco heating” or “toasting”.

The proposed smoking device likewise has an intake-opening arrangement 8 for taking in the liquid vapor, and for taking in the tobacco vapor, from the housing 1. In particular, this arrangement may be in the form of one or more intake openings. As proposed, the liquid vapor here flows in a liquid-flow channel 9 from the liquid-heating device 4 to the intake-opening arrangement 8 and the tobacco vapor flows in a tobacco-flow channel 10 from the chamber interior 6a to the intake-opening arrangement 8. A breathing-in or drawing action at the intake-opening arrangement 8 allows the user to breathe in the liquid vapor and the tobacco vapor. According to the illustration of FIGS. 1, 2, 3 and 4, the intake-opening arrangement 8 may have a single intake opening 8a.

The proposed smoking device, then, is characterized in that the liquid-flow channel 9 runs in the housing 1, outside the chamber interior 6a. In other words, the liquid-flow channel 9 avoids the interior of the heating chamber 6 and, in particular, does not lead through the chamber interior 6a. Rather, there is a distance between the liquid-flow channel 9 and the chamber interior 6a. However, it is possible here, in principle, for the liquid-flow channel 9 to run externally along the heating chamber 6, as long as it does not pass through the chamber interior 6a. In particular, it is also possible for the liquid evaporator 2 to be arranged downstream of the tobacco-flow channel 10.

In this regard and according to a first preferred variant, this course of the liquid-flow channel 9 taken outside the chamber interior 6a is achieved by the tobacco-flow channel 10 passing through the liquid-heating device 4. In other words, the tobacco-flow channel 10 leads through the liquid-heating device 4, as can be seen, in particular, in FIGS. 1, 5 and 6 for these exemplary embodiments.

Following the liquid-heating device 4, it can be seen according to FIGS. 1, 5 and 6 that the tobacco-flow channel 10 and the liquid-flow channel 9 coincide. Accordingly, it is preferred if, downstream of the liquid-heating device 4, this directionally related information referring both to the flow of the liquid vapor and to the flow of the tobacco vapor, the tobacco-flow channel 10 corresponds to the liquid-flow channel 9. That is to say, it is also the case here that the liquid-flow channel 9 runs, visibly outside the chamber interior 6, since the liquid-flow channel 9 is spaced apart from the heating chamber 6, as seen in the flow direction.

As an alternative, provision is made, as is illustrated in FIG. 4, in accordance with the second exemplary embodiment, for the liquid-flow channel 9 to be guided together with the tobacco-flow channel 10 at a channel junction 11, wherein the channel junction 11 is arranged in the tobacco-flow channel 10, downstream of the chamber interior 6a. The definition of downstream corresponds here, in turn, to the definition above. The liquid-flow channel 9 and the tobacco-flow channel 10 therefore combine for the first time outside the heating chamber 6, and thus also outside the chamber interior 6a, in which case there is essentially no liquid vapor entering into the heating chamber 6.

The liquid evaporator 2 and the tobacco heater 5 may be distributed between individual housing parts, this being illustrated for all exemplary embodiments in the figures. Provision is thus preferably made for the smoking device to have a liquid-evaporator module 12 with a liquid-evaporator-housing part 13, wherein the liquid evaporator 2 is arranged in the liquid-evaporator housing part 13. According to this preferred configuration, the smoking device also has a tobacco-heater module 14 with a tobacco-heater housing part 15, wherein the tobacco heater 5 is arranged in the tobacco-heater housing part 15.

It is also preferred if the liquid-evaporator module 12 is connected to the tobacco-heater module 14 in a releasable manner by a module connection. Provision may preferably be made for this module connection to establish a mechanical and an electrical connection between the evaporator module 12 and the tobacco-heating module 14. Both exemplary embodiments illustrate appropriate module contacts 16 for such an electrical connection.

In order to establish this module connection, provision is preferably made for the liquid-evaporator module 12 to have an evaporator-connecting arrangement 17 and for the tobacco-heater module 14 to have a heater-connecting arrangement 18, each for establishing the module connection. The module connection, as illustrated in FIGS. 1, 4, 5 and 6, is preferably a bayonet connection, that is to say a connection in the manner of a bayonet closure. Accordingly, it is possible for the evaporator-connecting arrangement 17 and the heater-connecting arrangement 18 each to have bayonet-connecting means, e.g. appropriate bayonet pins or bayonet slots.

As already described, both the chamber-heating device 7 and the liquid-heating device 4 are supplied preferably with electrical energy. It is therefore preferred if the smoking device comprises a storage-battery module 19 with a storage-battery housing part 20 and an electric power source 21, arranged in the storage-battery housing part 20. This electric power source 21 is intended for operating the chamber-heating device 7 and the liquid-heating device 4. The electric power source 21 may be a straightforward battery or a rechargeable battery, e.g. one based on lithium ions. For the purpose of charging up the electric power source, the smoking device may have charging contacts (not shown here) which are arranged on the housing 1 and are intended for electrically charging up the electric power source.

According to one option, the storage-battery module 19, and specifically the storage-battery housing part 20, is formed in one piece with one of the other modules or housing parts. It is therefore the case in the first exemplary embodiment of FIG. 1, in the third exemplary embodiment of FIG. 5 and in the fourth exemplary embodiment of FIG. 6 that the storage-battery module 19, and thus also the storage-battery housing part 20, is configured in one piece with the tobacco-heater module 14 and the tobacco-heater housing part 15.

On the other hand, provision may also be made, in accordance with a preferred variant and corresponding to the second exemplary embodiment of FIG. 4, for the storage-battery module 19 to have a storage-battery connecting arrangement 22 for establishing a storage-battery connection. This storage-battery connection may likewise be a bayonet connection. Accordingly, it is also possible for the storage-battery connecting arrangement 22 to comprise bayonet-connecting means, which is likewise illustrated in FIG. 4. It is also possible to provide, in particular, for the storage-battery connection to be a mechanical and electrical connection to the tobacco-heater module 14 and/or to the liquid-evaporator module 12. In the exemplary embodiment of FIG. 4, there is such a connection between the storage-battery module 19 and the liquid-evaporator module 12.

The storage-battery connection above may be a bayonet connection which is identical to the above module connection between the liquid-evaporator module 12 and the tobacco-heater module 14. It is then possible for the storage-battery connecting arrangement 22, equally, to establish a bayonet connection with the evaporator-connecting arrangement 17 and the heater-connecting arrangement 18. In respect of the exemplary embodiment of FIG. 4, it would thus be possible to change over for example the position of the tobacco-heater module 14 and that of the liquid-evaporator module 12—while maintaining the functionality of the smoking device overall.

A corresponding identical connection, which is also a bayonet connection, can also be established in a releasable, and thus flexible, manner between the tobacco-heater module 14—as shown in FIG. 4 —, or as an alternative the liquid-evaporator module 12, and a separate mouthpiece module 23. It would also be possible to replace the tobacco-heater module 14 or the liquid-evaporator module 12 with a dummy module (not illustrated), which is essentially identical in respect of its housing and also has identically configured connecting arrangements, but provides merely for the lead-through of electric lines and flow channels.

This allows the smoking device to be configured dynamically such that only the functionality of either the remaining tobacco-heater module 14 or the remaining liquid-evaporator module 12 is maintained. In this way, it is also possible to add in one or more further functional modules and to arrange them, for example, between the liquid-evaporator module 12 and the tobacco-heater module 14—based on the embodiment of FIG. 4.

A smoking device like that proposed usually has a control arrangement 24 which, in the examples described here, comprises a printed circuit board 25a and electronic components 25b arranged on the printed circuit board 25a. By means of such a control arrangement 24, for example the voltage provided by the electric power source 21 is connected to the liquid-heating device 4 or to the chamber-heating device 7. It is therefore preferred if the smoking device comprises a control arrangement 24 for activating the chamber-heating device 7 and preferably also the liquid-heating device 4, wherein the activation of the chamber-heating device 7 serves for optionally heating the heating chamber 6 to a pre-heating temperature or to a process temperature. At the pre-heating temperatune, there is essentially no tobacco vapor produced from the tobacco substance, but heating can continue comparatively quickly to the process temperature, at which said tobacco vapor is produced. The precise selection of the pre-heating temperature and of the process temperature may be dependent on the tobacco substance provided, e.g. on whether loose tobacco or a tobacco impregnated with a preparation is provided for use in the tobacco heater 5. The pre-heating temperature is, for example, 150° Celsius, in which case the process temperature may then be 165° Celsius. Higher process temperatures, however, are also conceivable, for example between 180° Celsius and 200° Celsius, or even up to approximately 300° Celsius. At higher process temperatures, it is also possible for the tobacco substance to burn at least in part.

It is preferable for the process temperature to be adjustable, in which case it is also possible to achieve a different smoking effect, for example, for different types of tobacco or additive substances. For this purpose, the control arrangement 24 preferably has an input device 26 for adjusting the process temperature. As illustrated in the exemplary embodiments, this input device 26 may be a touch-contact device 26a. Actuation of this touch-contact device 26a makes it possible to change between different, e.g. pre-set and selectable, process temperatures. The selection which is currently valid can then be displayed optically, for example, by an LED arrangement (not illustrated here). It would also be conceivable to have a rotating ring as the input device 26. The input device 26 may also serve for switching on the smoking device and, in particular, for initiating pre-heating of the heating chamber 6 to the pre-heating temperature.

The control arrangement 24 may also provide for control of the liquid-heating device 4 and of the chamber-heating device 7 via the drawing air. If the control arrangement 24 senses, via a corresponding sensor unit, a breathing-in or “drawing” action at the intake-opening arrangement 8 on the part of the user, it is possible for the liquid-heating device 4 to be energized, and/or for the chamber-heating device 7 to be activated, such that the process temperature for generating the tobacco vapor is reached. Also conceivable here are more complex control means which react in a certain way, for example, to a pulsed breathing-in action. It would also be conceivable to start the operation of pre-heating to the pre-heating temperature, or to adjust the process temperature, via such drawing-air control.

One aspect of such a smoking device is constituted by the operation of filling the heating chamber 6, which can be done, for example, with loose tobacco—as illustrated in FIG. 6—or with special tobacco pads 27—as illustrated in each case in FIGS. 1, 3, 4 and 5—wherein these tobacco pads 27 comprise either natural or prepared tobacco in a closed capsule. Tobacco pads 27 of this kind are also referred to as “pellets”. Provision is preferably made here for the smoking device to have an openable filling cap 28 for covering the heating chamber 6, wherein, in the open state of the filling cap 28, the chamber interior 6a can be filled with the tobacco substance. As already stated, this may be in the form of both loose tobacco and a tobacco pad 27.

It is also preferred if, as illustrated in the respective exemplary embodiment of FIGS. 1, 5 and 6, the filling cap 28 is formed by a cap arrangement 28a of the liquid-evaporator module 12. In this exemplary embodiment, this cap arrangement 28a is also a constituent part of the evaporator-connecting arrangement 17.

This results in the preferred variant, in accordance with which, by virtue of the module connection being released, the filling cap 28 is opened by being separated—in this case by the liquid-evaporator module 12 being separated—from the heating chamber 6. The releasable module connection between the liquid-evaporator module 12 and the tobacco-heater module 14, which is required in any case for exchanging the liquid-evaporator module 12, e.g. on account of the liquid being used up, can thus also be used for access to the heating chamber 6. This does away with the need of having to provide a separate filling cap 28 with a corresponding opening mechanism. It is possible for the filling cap 28—as illustrated for the exemplary embodiments—to have a capsule spike 28b for piercing the tobacco pad 27.

In respect of an entrance for the air, which can then be sucked out of the intake-opening arrangement 8, provision is preferably made for the smoking device to have an inlet-opening arrangement 29, in which case any air stream entering flows through the liquid-flow channel 9 and/or through the tobacco-flow channel 10 to the intake-opening arrangement 8. On the one hand, as in the exemplary embodiment of FIGS. 1, 5 and 6, it is possible for this inlet-opening arrangement 29 to be arranged in the tobacco-heater housing part 15. It is likewise possible for the inlet-opening arrangement 29 to be arranged in the storage-battery housing part 20, which is shown in the exemplary embodiment of FIG. 4.

In this connection, provision is preferably also made that an inlet-flow channel 33 for the entering air stream runs from the inlet-opening arrangement 29 to the heating chamber. In particular, it is possible that the inlet-flow channel 33 runs to a chamber inlet opening 32a of the heating chamber 6, wherein the chamber inlet opening 32a is designed for the inflow of the entering air stream, such that the entering air stream for taking up the tobacco vapor at least partially crosses the heating chamber 6. In particular, it is possible that the inlet-flow channel 33 divides into a first inlet sub-channel 33a and a second inlet sub-channel 33b, in which case—according to the views in FIG. 5 and in FIG. 6—only the first inlet sub-channel 33a then leads to the chamber inlet opening 32a of the heating chamber 6, and only the corresponding portion of the entering air stream in turn at least partially crosses the heating chamber 6 in order to take up the tobacco vapor.

Provision is preferably made for the heating chamber 6 to be cylindrical and to have a closed lateral surface 30. The heating chamber 6 itself may also have a closed base surface 31—as illustrated in the second exemplary embodiment of FIG. 4—an at least partially open base surface also being possible here as an alternative, this applying especially to the third and fourth exemplary embodiments according to FIG. 5 and FIG. 6, respectively, since the partially open base surface 31 in these embodiments stems from the chamber inlet opening 32a of the heating chamber 6.

It is also preferred if the heating chamber 6 has a chamber-outlet opening 32b for the outflow of tobacco vapor. As illustrated for all exemplary embodiments, this chamber-outlet opening 32b may be formed by a partially or—as is the case here
fully open, and therefore absent, roof surface of the heating chamber 6. As far as the inlet-opening arrangement 29 is concerned, provision may also be made for the inlet-flow channel 33 to run from the inlet-opening arrangement 29 to the chamber-outlet opening 32b, which is shown here in the first two exemplary embodiments according to FIGS. 1 and 4. Alternatively, however, provision can also be made that a bypass flow channel 33c runs from the inlet opening arrangement 29 to the chamber outlet opening 32b. This bypass flow channel 33c can be present as an alternative or as an addition to a flow channel—here the first inlet sub-channel 33a-which runs from the inlet opening arrangement 29 to a chamber inlet opening 32a of the heating chamber 6. In the exemplary embodiments in FIGS. 5 and 6, this bypass flow channel 33c corresponds in each case to the second inlet sub-channel 33b.

It is also preferable that the chamber inlet opening 32a is arranged in a base surface 31 of the heating chamber 6, and especially opposite the chamber outlet opening 32b. The chamber inlet opening 32a and the chamber outlet opening 32b can be arranged on a longitudinal axis 36 of the housing 1. These features are likewise shown in FIGS. 5 and 6 for the third and fourth exemplary embodiments.

Especially in the case where the entering air stream for taking up the tobacco vapor at least partially crosses the heating chamber 6, an effective separation of the solid tobacco substance from the entering air stream may be desirable, so that only the tobacco vapor is entrained and, by contrast, all the solid constituents of the tobacco substance remain in the chamber interior 6a. It is therefore preferable that the heating chamber 6 has an air-permeable separating arrangement 6b for separation of the tobacco substance, such that the entering air stream crosses the heating chamber 6 separated from the tobacco substance by the separating arrangement 6. As is shown especially in the fourth exemplary embodiment in FIG. 6, the separating arrangement 6b can have a tubular shape and can be provided with pore-like openings. The pore-like openings are preferably configured such that they allow the tobacco vapor to pass through but reliably hold back the tobacco substance. By contrast, the third exemplary embodiment in FIG. 5 shows a variant in which the tobacco pad 27 has a shell, which itself allows air to pass through in this way at the relevant sections and at the same time is otherwise impermeable to the tobacco substance.

As is likewise shown in the fourth exemplary embodiment in FIG. 6, it is also preferable that the separating arrangement 6 is designed for closure engagement with the filling cap 28. Since, according to this exemplary embodiment, the entering air stream, upon leaving the heating chamber 6, is preferably intended to pass through the filling cap 28 and to flow into the liquid-evaporator module 12, it is thus possible—in the opened state of the filling cap 28—for the opening present in the separating arrangement 6 to be closed. This closure engagement preferably takes place with the cap arrangement 28a, i.e. preferably with a constituent part of the evaporator-connecting arrangement 17. As is likewise shown in FIG. 6, this part can be the capsule spike 28b, which here protrudes into the chamber interior 6a.

In the case of a heating chamber 6 in the form of a straightforward cylinder, the tobacco substance is heated exclusively by the lateral surface 30 and possibly the base surface 31 and by any roof surface which may be present. In order to increase the effective surface area for heating purposes, provision may also be made for the heating chamber 6 to have a cylindrical or conical inner protrusion 34 which can be heated by the chamber-heating device 7, as is illustrated for the first two exemplary embodiments in FIGS. 1, 3 and 4.

The increase in temperature which accompanies the operation of heating the heating chamber 6 is not usually desirable either at the liquid-heating device 4 or at the housing 1. In order to minimize an increase in temperature at these locations, provision is therefore preferably made for the tobacco heater 5 to have a thermal barrier 35 for thermally insulating the heating chamber 6. In order also to allow the heating chamber 6, specifically the chamber interior 6a, to be cleaned of tobacco-substance residues, the heating chamber 6 preferably has a ceramic inner coating.

A particularly ergonomic shape and advantageous modularity are achieved for the smoking device if—as illustrated for both exemplary embodiments—the housing 1 is essentially cylindrically switched and the liquid evaporator 2 as well as the tobacco heater 5 are arranged on the longitudinal axis 36 of the housing 1. This arrangement on the longitudinal axis 36 preferably also applies to the liquid-evaporator module 12 and as an alternative, or in addition, to the tobacco-heater module 14.

The illustrated exemplary embodiments differ, as already described, in respect of the order in which the liquid evaporator 2 and the tobacco heater 5 are arranged in respect of the flow direction. The exemplary embodiments of FIG. 1 and of FIGS. 5 and 6, then, provide for the intake-opening arrangement 8 to be arranged at a mouthpiece end 35 of the smoking device and, as seen in relation to the longitudinal axis 36, for the liquid evaporator 2, preferably also the evaporator module 12, to be arranged on the mouthpiece side in relation to the tobacco heater 5, and thus preferably also on the mouthpiece side in relation to the tobacco-heater module 14. In other words, the liquid evaporator 2 is placed between the mouthpiece end 35 and the tobacco heater 5 not just in respect of flow, but also geometrically. In contrast, the embodiment of FIG. 4 makes provision, as seen in relation to the longitudinal axis 36, for the tobacco heater 5, and preferably also the tobacco-heater module 14, to be arranged on the mouthpiece side in relation to the liquid evaporator 2, and preferably also in relation to the liquid-evaporator module 12.

It is precisely for the variants of FIGS. 1 and 5 and 6, in which the tobacco vapor is guided through the liquid heating device 4, that the liquid heating device 4 may become contaminated by said tobacco vapor. It is therefore preferred if the smoking device, and in particular the liquid evaporator 2, comprises a filter arrangement 37, preferably an active carbon filter, in the tobacco-flow channel 10, and it is possible here specifically for said filter arrangement 37 to be arranged in the tobacco-flow channel 10 between the heating chamber 6 and the liquid heating device 4, as can also be gathered from the illustration of FIGS. 1 and 5 and 6.

1. Smoking device having a housing (1), having a liquid evaporator (2), which is arranged in the housing (1) and has a reservoir (3) for liquid and also a liquid-heating device (4) for evaporating the liquid into liquid vapor, and having a tobacco heater (5), which is arranged in the housing (1) and has a heating chamber (6) for accommodating a tobacco substance in a chamber interior (6a) and also a chamber-heating device (7) for generating tobacco vapor from the tobacco substance, and having an intake-opening arrangement (8) for taking in the liquid vapor, and for taking in the tobacco vapor, from the housing (1), wherein the liquid vapor flows in a liquid-flow channel (9) from the liquid-heating device (4) to the intake-opening arrangement (8) and the tobacco vapor flows in a tobacco-flow channel (10) from the chamber interior (6a) to the intake-opening arrangement (8),
characterized in that
the liquid-flow channel (9) runs in the housing (1), outside the chamber interior (6a).

2. Smoking device according to claim 1, characterized in that the tobacco-flow channel (10) passes through the liquid-heating device (4), preferably in that, downstream of the liquid-heating device (4), the tobacco-flow channel (10) corresponds to the liquid-flow channel (9).

3. Smoking device according to claim 1, characterized in that the liquid-flow channel (9) is guided together with the tobacco-flow channel (10) at a channel junction (11), wherein the channel junction (11) is arranged in the tobacco-flow channel (10), downstream of the chamber interior (6a).

4. Smoking device according to one of claims 1 to 3, characterized in that the smoking device has a liquid-evaporator module (12) with a liquid-evaporator housing part (13), wherein the liquid evaporator (2) is arranged in the liquid-evaporator housing part (13), and has (15) a tobacco-heater module (14) with a tobacco-heater housing part, wherein the tobacco heater (5) is arranged in the tobacco-heater housing part (15), preferably in that the liquid-evaporator module (12) is connected to the tobacco-heater module (14) in a releasable manner by a module connection, in particular in that the module connection establishes a mechanical and an electrical connection between the liquid-evaporator module (12) and the tobacco-heater module (14).

5. Smoking device according to claim 4, characterized in that the liquid-evaporator module (12) has an evaporator-connecting arrangement (17) and the tobacco-heater module (14) has a heater-connecting arrangement (18), each for establishing the module connection, preferably in that the module connection is a bayonet connection.

6. Smoking device according to one of claims 1 to 5, characterized in that the smoking device has a storage-battery module (19) with a storage-battery housing part (20) and an electric power source (21), arranged in the storage-battery housing part (20), for operating the liquid-heating device (4) and the chamber-heating device (7), preferably in that the smoking device has charging contacts which are arranged on the housing (1) and are intended for electrically charging up the electric power source (21).

7. Smoking device according to claim 6, characterized in that the storage-battery module (19) has a storage-battery connecting arrangement (22) for establishing a storage-battery connection, said storage-battery connection preferably being a bayonet connection, in particular in that the storage-battery connection is a mechanical and electrical connection to the tobacco-heater module (14) and/or to the liquid-evaporator module (12).

8. Smoking device according to one of claims 1 to 7, characterized in that the smoking device comprises a control arrangement (24) for activating the chamber-heating device (7), preferably also the liquid-heating device (4), for optionally heating the heating chamber (6) to a pre-heating temperature or to a, preferably adjustable, process temperature, in particular in that the control arrangement (24) has an input device (26), preferably a touch-contact device (26a), for adjusting the process temperature.

9. Smoking device according to one of claims 1 to 8, characterized in that the smoking device has an openable filling cap (28) for covering the heating chamber (6), wherein, in the open state of the filling cap (28), the chamber interior (6a) can be filled with tobacco substance, preferably in that the filling cap (28) is formed by a cap arrangement (28a) of the liquid-evaporator module (12), in particular in that, by virtue of the module connection being released, the filling cap (28) is opened by being separated from the heating chamber (6).

10. Smoking device according to one of claims 1 to 9, characterized in that the smoking device has an inlet-opening arrangement (29), in which case an entering air stream flows through the liquid-flow channel (9) and/or through the tobacco-flow channel (10) to the intake-opening arrangement (8).

11. Smoking device according to claim 10, characterized in that an inlet-flow channel (33) for the entering air stream runs from the inlet-opening arrangement (29) to the heating chamber (6), in particular to a chamber inlet opening (32a) of the heating chamber (6) for the inward flow of the entering air stream, such that the entering air stream for taking up the tobacco vapor at least partially crosses the heating chamber (6).

12. Smoking device according to one of claims 1 to 11, characterized in that the heating chamber (6) is cylindrical and has a closed lateral surface (30), in particular has a closed base surface (31).

13. Smoking device according to one of claims 1 to 12, characterized in that the heating chamber (6) has a chamber outlet opening (32b) for the outward flow of tobacco vapor, preferably in that the chamber inlet opening (32a) is arranged in a base surface (31) of the heating chamber (6), especially opposite the chamber outlet opening (32b), and more preferably in that the chamber inlet opening (32a) and the chamber outlet opening (32b) are arranged on a longitudinal axis (36) of the housing (1).

14. Smoking device according to claim 13, characterized in that the heating chamber (6) has an air-permeable separating arrangement (6b) for separation of the tobacco substance, such that the entering air stream crosses the heating chamber (6) separated from the tobacco substance by the separating arrangement (6).

15. Smoking device according to claim 14, characterized in that the separating arrangement (6) is designed for closure engagement with the filling cap (28), preferably with the cap arrangement (28a) and in particular with a capsule spike (28b) which protrudes into the chamber interior (6a).

16. Smoking device according to one of claims 1 to 15, characterized in that a bypass-flow channel (33c) runs from the inlet-opening arrangement (29) to the chamber-outlet opening (32b), in particular in that the heating chamber (6) has a cylindrical or conical inner protrusion (34) which can be heated by the chamber-heating device (7).

17. Smoking device according to claim 16, characterized in that the intake-opening arrangement (28) is arranged at a mouthpiece end (35) of the smoking device, and in that, as seen in relation to the longitudinal axis (36), the liquid evaporator (2), preferably the liquid-evaporator module (12), is arranged on the mouthpiece side in relation to the tobacco heater (5), preferably in relation to the tobacco-heater module (14).
